(19) United States
(12) Patent Application Publication
(10) Pub. No.: US 2001/0033419 A1
(43) Pub. Date: Oct. 25, 2001

(54) Direction of optical signals by a movable diffractive optical element

(76) Inventors: Jefferson E. Odhner, Amherst, NH (US); Elliott S. Luckoff, Columbus, OH (US); Donald L. Cullen, Columbus, OH (US); Ken G. Wasson, Foster City, CA (US)

Correspondence Address: Diane E. Burke, Mueller and Smith, LPA, Mueller-Smith Building, 7700 Rivers Edge Drive, Columbus, OH, 43235, US

(21) Appl. No.: 09/836,685

(22) Filed: Apr. 17, 2001

Related U.S. Application Data
(63) Continuation-in-part of application No. 09/372,316, filed on Aug. 11, 1999, now abandoned.

(51) Int. Cl. G02B 5/32; G03H 1/00; G02B 5/18

(52) U.S. Cl. 359/573; 359/34; 359/15

(57) ABSTRACT

A method and apparatus particularly useful for telecommunications applications, such as switching (Add/Drop), multiplexing and demultiplexing, is disclosed. The method commences by directing a source of input optical signal(s) (10) onto a movable diffractive optical element or MDOE. Each of the optical signals is associated with a particular wavelength. Next, one or more output stations are supplied. Finally, the MDOE generates and distributes output optical signals among the output station(s). The corresponding system for treating the optical signals from a source thereof includes a source carrying two or more input optical signals, each of the signals being associated with a particular wavelength. Also included is a movable diffractive optical element positioned to intercept the source optical signals for producing and distributing one or more diffracted output optical signals. Finally, one or more output stations are positioned to receive the diffracted optical signal(s) from the MDOE.

### CROSS-REFERENCE TO RELATED APPLICATIONS

This application is cross-referenced to commonly assigned Application Ser. No. 09/663,850, filed on Sep. 18, 2000 (Attorney Docket No. LUC 2-027-3), the disclosure of which is herein incorporated by reference.

### BACKGROUND OF THE INVENTION

Within a fiber optic network, information from a source, in the form of an electrical signal, is converted to an optical signal that can then be transmitted along a fiber optic cable to the intended destination where it is converted back to an electrical signal. In the modern world of Internet access, facsimiles, multiple telephone lines, modems, and teleconferencing, an incredible burden is placed on telecommunications networks to meet the ever-increasing demand for information transmission services. Unaware of the capacities that would be required of fiber optic cables, relatively narrow bandwidths were calculated using classical engineering formulas, such as Poisson and Reeling. The increased service needs imposed upon these cables have resulted in fiber exhaustion and a concomitant need for layered bandwidth management. For information on telecommunications networks, see generally:

(1) www.webproforum.com/lucent3

One option for meeting the increased demand for information transmission is to lay additional optical fiber cable. This option can be expensive, however, and is generally only practicable where the increased demand is relatively small. Another method for dealing with this problem is called time division multiplexing (TDM). This method increases the speed at which the data is transmitted, speed being measure in bits per second (bps). The bit rate is increased by slicing time into smaller increments such that a greater number of bits can be transmitted per unit time (e.g., per second). A drawback to this approach is that the detector temporal frequency response limits the number of bits that can be transmitted per unit time.

Because of the limitations associated with TDM, another technique was devised for carrying increased data load over existing fibers called wavelength division multiplexing (WDM). WDM involves slicing up the laser diode transmitter output wavelengths into multiple increments, each increment being modulated separately to increase the number of bits that can be transmitted per second. When the number of slices increases past a certain point, the system is referred to as a DWDM (Dense Wave Division Multiplexing) system.

DWDM increases capacity by assigning incoming optical signals to specific frequencies within a designated frequency band, multiplexing the resulting signals, and transmitting the resulting multiplexed signal via a single fiber. The signals are thus transmitted as a group over a single fiber. Spacing between the increments also is decreased using TDM with DWDM so that a greater number of bits are transmitted per second. The signals then are demultiplexed and routed by individual cables to their destination. The transmitted signals can travel within the fiber optic cable at different speeds and in different formats, and the amount of information that can be transmitted is limited only by the speed at which the signals travel and the number of frequencies, or channels, available within the fiber.

A number of technological advances have made DWDM possible. Once such advance was the discovery that by using fused biconic tapered couplers, more than one signal can be sent on the same fiber. The result of this discovery was an increase in the bandwidth for one fiber. Another important advance was the use of optical amplifiers. By doping a small strand of fiber with a rare earth element, usually erbium, an optical signal can be amplified without converting it back to an electrical signal. Optical amplifiers now are available which provide more efficient and precise flat gain with significant total power output of about 20 dBm.

Narrowband lasers have also contributed to the increased capacity of telecommunications networks. These lasers provide a narrow, stable, and coherent light source, each source providing an individual “channel.” Generally, 40 to 80 channels are available for a single fiber. Researchers are working on creating new methods for increasing the number of channels available for each fiber. Lucent Technology's Bell Laboratories has demonstrated a technique for multiplexing, or combining, 300 channels within an 80 nm segment of the spectrum using a femtosecond laser. See:

(2) Brown, Chappell, “Optical Interconnects Getting Supercharged,” Electronic Engineering Times, May 25, 1998; pp. 39-40.

Given the greater number of channels, and corresponding signals, which can be carried on a single optical fiber, multiplexing and demultiplexing has become increasingly important. Current methods for multiplexing and demultiplexing include the use of thin film substrates or fiber Bragg gratings. For the first method, a thin film substrate is coated with a layer of dielectric material. Only signals of a given wavelength will pass through the resulting substrate. All other signals will be reflected. See, for example, U.S. Pat. No. 5,457,573. With fiber Bragg gratings, the fiber optic cable is modified so that one wavelength is reflected back while all the others pass through. Bragg gratings are particularly used in add/drop multiplexers. With these types of systems, however, as the number of transmitted signals increases, so does the number of required films or gratings for multiplexing and demulitplexing. See U.S. Pat. Nos. 5,748,350 and 4,923,271. Therefore, more efficient, less expense methods for multiplexing and demultiplexing transmitted signals continue to be sought.

### BRIEF SUMMARY OF THE INVENTION

A method and apparatus particularly useful for telecommunications applications, such as switching, multiplexing and demultiplexing, is disclosed. The method commences by directing a source of input optical signal(s) (10) onto a movable diffractive optical element or MDOE. A rotatable diffractive optical element (RDOE) provides the most efficient type of MDOE. Each of the optical signals is associated with a particular wavelength. Next, one or more output station(s) are supplied. Finally, the RDOE (12) generates output optical signal(s) and distributes them among the output station(s). The corresponding system for treating the optical signals from a source thereof includes a source carrying one or more input optical signals, each of the signals being associated with a particular wavelength. Also included is a movable diffractive optical element positioned to intercept the source optical signals for producing one or more diffracted output optical signals. Finally, one or more output stations are positioned to receive the one or more diffracted output optical signals from the MDOE. “Diffractive Optical Elements” for use in the present invention bear diffraction gratings for achieving their optical diffraction properties.

### BRIEF DESCRIPTION OF THE DRAWINGS

For a fuller understanding of the nature and objects of the present invention, reference should be made to the following detailed description taken in conjunction with the accompanying drawings, in which:

FIG. 1 is a schematic representation of an RDOE switching input optical signals emitted by a laser diode assembly onto lenses that are associated with optical fibers;

FIG. 2 is a schematic representation like that in FIG. 1, except that the output optical signals are being switched to different lens pairs;

FIG. 3 is a schematic representation of an RDOE multiplexing input optical signals from an optical fiber to four different output optical fibers (the number of output optical fibers being illustrative rather than limitative of the present invention);

FIG. 4 is a schematic representation of an RDOE demultiplexing four input optical signals from four laser diode assemblies to two optical fibers (the number of input and output signals/optical fibers being illustrative rather than limitative of the present invention);

FIG. 5 is a schematic representation of an RDOE switching three input optical signals to all possible combinations of three optical output fibers (the number of input/output optical fibers being illustrative rather than limitative of the present invention);

FIG. 6 is a top view of FIG. 5;

FIG. 7A is a top view illustrating the tilting magnetic embodiment of an RDOE;

FIG. 7B is a side view of the RDOE of FIG. 7A which shows the connection of a magnet and coil to a printed circuit board;

FIG. 8 is simplified cross-sectional view of a plate bearing four posts whose ends carry diffractive gratings of different spacing for diffracting an input optical signal (the number of posts and diffractive gratings being illustrative rather than limitative of the present invention) and

FIG. 9 is a simplified perspective view of a plate whose surface carries a diffraction grating for diffracting an input signal into a plurality of output wavelengths.

The drawings will be described in detail below.

### DETAILED DESCRIPTION OF THE INVENTION

The present invention provides a simple and elegant method for distributing optical signals which may be utilized in a variety of uses, such as multiplexing, demultiplexing, switching, or any other application where it is desirable to separate, combine or direct optical signals. Use of a movable diffractive optical element (RDOE) eliminates the need for optical apparatus, such as mirrors, filters, and thin films, which optical apparatus add complexity and expense proportionally as the number of optical signals to be treated increases.

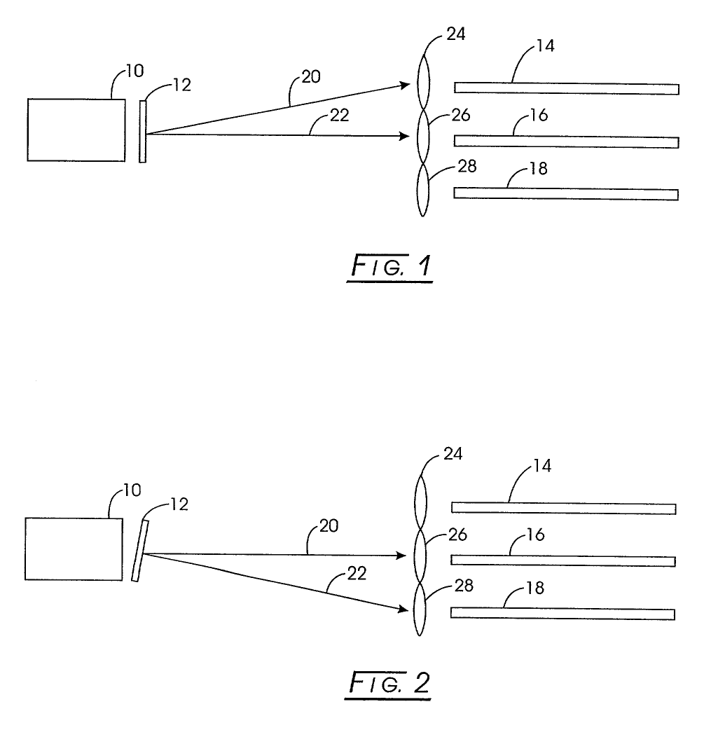

Referring to the drawings, FIG. 1 a schematic representation of an RDOE switching input optical signals emitted by a laser diode assembly onto lens that are associated with optical fibers. A source is provided, as represented by numeral 10, which source is composed of one or more input optical signals, each of which is associated with a particular wavelength (λ) or energy. In accordance with the convention in the field, the term “wavelength” is used in this Application to mean one or more wavelengths or a band of wavelengths. Also throughout this application, an “s” in parenthesis following a given element is used to indicate the presence of at least one or more of that element. For example, the term “optical signal(s)” means one or more optical signals. Source 10 in FIG. 1 is provided by a laser diode assembly, however, any other device or combination of devices capable of supplying modulated optical signal(s) may be used. Such a device or devices, for example, may include optical cable or fiber. Source 10 is directed toward the surface of rotatable diffractive optical element (RDOE) 12. RDOE 12 diffracts the input optical signal(s) of source 10 at different angles according to the diffractive equation:

(a) λ=d(sinₗ+sinδ)

where,

λ=wavelength of diffractive light (microns)

d=grating spacing of one cycle (microns)

l=angle of incidence from plate normal (degrees)

δ=angle of diffraction from plate normal (degrees).

For a fixed d and a fixed λ, rotation of the RDOE in effect varies l to allow different wavelengths to be diffracted at different angles, δ, thereby generating output optical signals. Specific characteristics and embodiments of the RDOE 12 will be discussed in greater detail later.

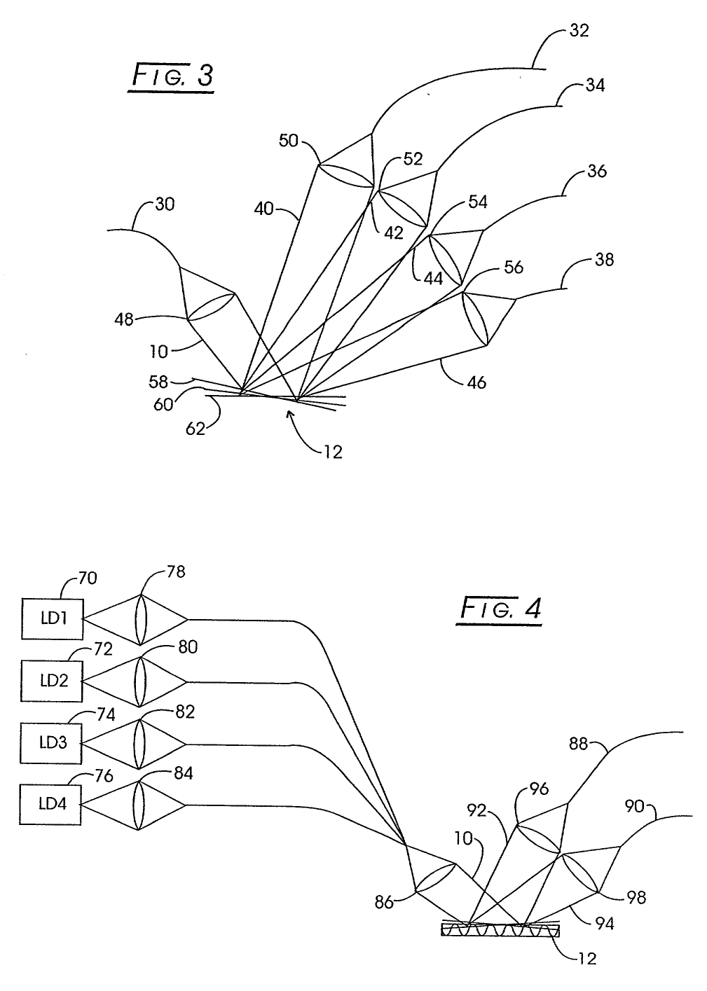

Three output stations are provided, as at 14, 16 and 18, for receiving the diffracted output optical signals, λ1 and λ2, as shown at 20 and 22, respectively. With RDOE 12 at a first position as depicted in FIG. 1, output stations 14 and 16 receive output optical signals 20 and 22. FIG. 2 depicts RDOE 12 rotated to a second position, the rotation direction being in the plane parallel to RDOE 12. In this second position, the angle at which the optical signals are diffracted has changed and output optical signals now are directed at output stations 16 and 18. Thus, by rotating RDOE 12, optical signal(s) may be switched among a number of output station(s). Output stations 14, 16, and 18 shown in FIGS. 1 and 2 are optical fibers, but the output station(s) may be any mechanism capable of detecting or transmitting an optical signal. A system for switching a source among three output stations illustrates a simple use of the method of the invention. As will be illustrated later, the simplicity of the method facilitates distribution of source of optical signals among a multitude of output stations. A lens assembly for focusing the optical signal(s) is provided in conventional fashion, for example, as shown at 24, 26, and 28 in FIGS. 1 and 2. Structure necessary to implement such a lens assembly is not described herein as it is well-known to those skilled in the art.

FIG. 3 illustrates the method of the present invention in a multiplexing application, the input optical signal(s) of source 10 being supplied by optical fiber 30. Input optical signals, λ1, λ2, λ3, and λ4, being transmitted along fiber 30, are directed toward RDOE 12, which retains its earlier numeration. Output stations 32, 34, 36, and 38 are positioned to receive the generated output optical signals, λ1, λ2, λ3, and λ4, respectively, which are shown at 40, 42, 44, and 46, respectively. RDOE 12 is shown being rotated among three positions: 58, 60, and 62. Output stations, or optical fibers, 32, 34, 36, and 38, are the same as those output station(s) described with respect to FIG. 1, but similarly could be connected to any mechanism capable of detecting or transmitting an optical signal. A lens assembly again is present in the form of lenses 50, 52, 54, and 56 to focus the optical signals. Similarly, a lens assembly 48 focuses the optical signal(s) emanating from fiber 30 onto RDOE 12. Structure necessary to implement such a lens assembly is not described herein as it is well-known to those skilled in the art.

Table I, below, illustrates the distribution of input optical signals, λ1, λ2, λ3, and λ4, to the four output stations, 32, 34, 36 and 38, depending on the three different rotational positions of RDOE 12 as shown in FIG. 3.

TABLE I

| | Position 1 | Position 2 | Position 3 |
|---|---|---|---|
| Output Station 1 | — | W1 | W2 |
| Output Station 2 | W1 | W2 | W3 |
| Output Station 3 | W2 | W3 | W4 |
| Output Station 4 | W3 | W4 | — |

When RDOE 12 is in its first position, 58, λ1 is directed toward output station 34; signal λ2 is directed toward output station 36; and signal λ3 is directed toward output station 38. No output optical signal is received by output station 32. With the RDOE 12 in its second position, 60, in FIG. 3, optical signals λ1, λ2, λ3, and λ4 are directed to output stations 32, 34, 36, and 38, respectively. When RDOE 12 is in position 3, as at 62, output station 32 receives signal λ2, output station 34 receives signal λ3, and output station 36 receives signal λ4. No output optical signal is received by output station 38. Rotating RDOE 12 to other positions permits other combinations of output optical signals to be distributed among the output stations. In this regard, it will be appreciated that the number of output optical signal(s) and number of output station(s) depicted in the drawings is merely illustrative as a greater or lesser number could be used in accordance with the precepts of the present invention.

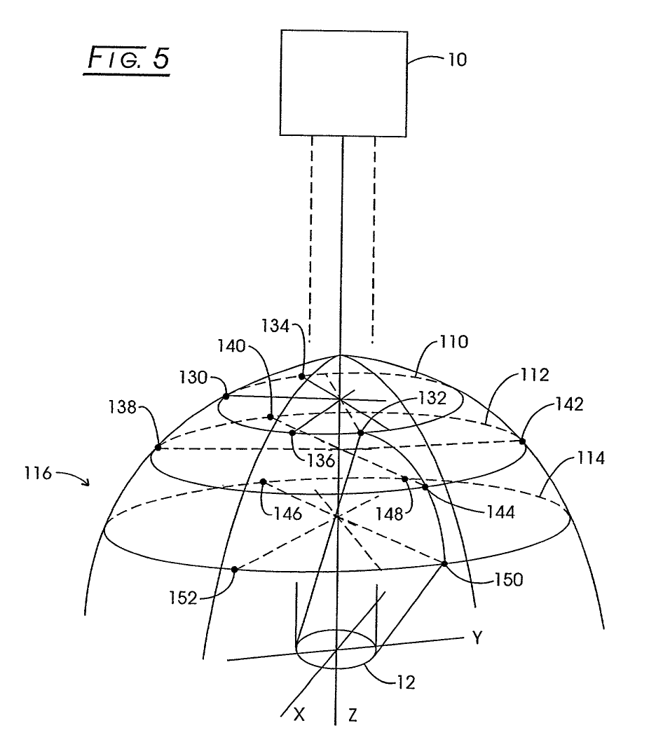

FIG. 4 shows yet another implementation of the present invention in a traditional demultiplexing application. Source 10 is originates from the combined output of four laser diode assemblies, 70, 72, 74, and 76. A lens assembly, in the form of lenses 78, 80, 82, 84, and 86, directs source 10, provided by the laser diode outputs from laser diode assemblies 70, 72, 74, and 76, onto the surface of RDOE 12. Output stations 88 and 90 are provided to receive diffracted output optical signals 92 and 94. In previous FIGS. 1-3, the output stations each received a single output optical signal. As shown in FIG. 4, however, the output stations also may receive multiple output optical signals. A lens assembly, composed of lenses 96 and 98, will determine what range of output optical signals will be directed to output stations 88 and 90, respectively. Again, rotation of RDOE 12 directs diffracted output optical signals 92 and 94 between and onto lenses 96 and 98.

FIG. 5 shows a 3-dimensional view of the present invention in a switching application, where all possible combinations of three input optical signals are directed onto three output lines, each combination corresponding to a different position of RDOE 12. Source 10 provides the three input optical signals, λ1, λ2, and λ3. These optical signals are directed onto RDOE 12 that is located below and parallel to source 10. Again, the number of source signals was chosen to illustrate the present invention and not as a limitation of it.

Optical connectors positioned to receive the diffracted output optical signals are spatially located along the surface of a hemisphere shown generally at 116. Output stations 110, 112, and 114 are located on lines of equal latitude on hemisphere 116. Four optical connectors are located along each latitude of output stations 110, 112, and 114. One wavelength is diffracted to all optical connectors located along each line of latitude. For example, output station 110, having optical connectors 130, 132, 134, and 136 will receive diffracted output optical signal λ1. Output station 112, having optical connectors 138, 140, 142, and 144, will receive output optical signal λ2. Output station 114, having optical connectors 146, 148, 150, and 152, will receive output optical signal λ3. λ3 will have a longer wavelength than λ2 which will have a longer wavelength than λ1.

While the output stations have been described as being along equal lines of latitude for efficiency, it will be appreciated by one skilled in the art that the output station(s) may be located along non-parallel latitudes so long as the optical connectors located thereon are non-intersecting. Further, the spatial positioning of the output station(s) have been described as being along the surface of a hemisphere, however, this shape is intended to be illustrative and not limiting of the present invention. Positioning of the output station(s) around the RDOE may be in any desired configuration.

A conventional combiner (not shown) connects each output station's optical connectors to an output fiber or cable. If there are n output fibers, then there must be n combiners, i.e., one for each output station. For the example shown in FIG. 5, n 3. For example, a combiner will combine optical connectors 130, 132, 134, and 136 along output station 110 to a first optical fiber. Another will combine 138, 140, 142, and 144 to a second optical fiber. Finally, 146, 148, 150, and 152 will be combined and connected to a third optical fiber.

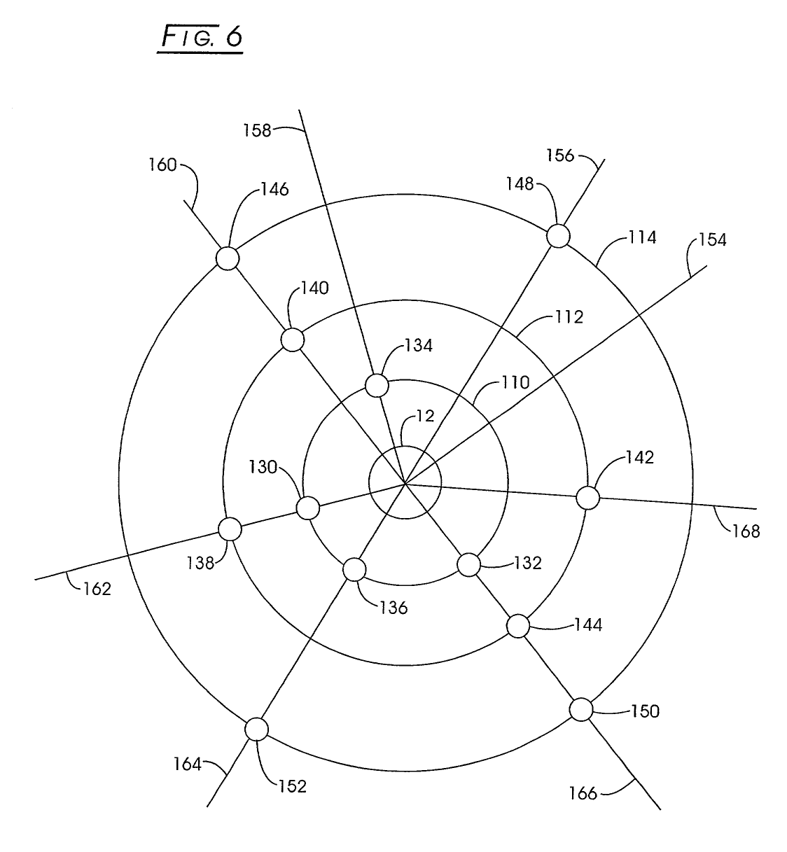

Looking to FIG. 6, a top view of the optical connectors illustrated in FIG. 5 is shown. The components of FIG. 6 retain the numeration of FIG. 5. RDOE 12 is rotatable to eight positions, shown at 154, 156, 158, 160, 162, 164, 166, and 168. In each position, wavelengths will be diffracted to optical connectors located along equal lines of longitude. (sphere 116, FIG. 5). Note that the RDOE 12 axis of rotation is perpendicular to the grating plane. When RDOE 12 is positioned at position 154, no output optical signals are conveyed to any optical connectors. At position 156, output optical signal λ3 will be received at output station 114. Output stations 110 and 112 will not receive signals. With RDOE 12 in a third position, as shown at 158, output optical signal λ1 will be received at output station 110 by optical connector 134. No output optical signal will be received at output stations 112 and 114. This grating will continue for all 8 positions.

Table II shows the optical signal combinations for each of the eight positions to which RDOE 12 is rotatable.

TABLE II

| Position No. | Output Station 1 | Output Station 2 | Output Station 3 |
|---|---|---|---|
| 1 | 0 | 0 | 0 |
| 2 | 0 | 0 | 1 |
| 3 | 0 | 1 | 0 |
| 4 | 1 | 0 | 0 |
| 5 | 1 | 0 | 1 |
| 6 | 0 | 1 | 1 |
| 7 | 1 | 1 | 0 |
| 8 | 1 | 1 | 1 |

When directing n input optical signals from source 10 to n output stations, there must be n·2ⁿ optical connectors, to permit all combinations of the n signals. Each of the n combiners will combine 2ⁿ⁻¹ optical connections. The resolution of RDOE 12, i.e., the number of positions to which it may be rotated, must be 360°/2ⁿ.

If the system depicted in FIG. 5 were being used in a multiplexing application, combiners would be used to combine the output of the optical connectors in each of the eight positions. For example, one combiner would combine optical connectors 132, 144, and 150. The output to the optical fiber would, thus, be optical signals of λ1, λ2, and λ3. Another combiner would be positioned to combine optical connectors 130 and 138. This output, optical signals λ1 and λ2, would be transmitted to a different optical fiber, and so on. In a multiplexing application, the number of combiners required would be 2ⁿ.

The present invention, then, includes directing of output optical signal(s) to one or more output stations by varying the effective spacing of a diffractive optical element through rotation. One embodiment for RDOE 12 involves the use of a diffraction grating on a thin film that is connected to an energy source, energizable for movement of the film. Such movement changes the effective spacing of the diffraction grating on the film. A diffractive grating or hologram may be embossed on the thin film to form the diffractive grating. The film may be PVDF or any other piezoelectric film that deforms by a small amount when subjected to an electric field. The diffractive grafting or hologram embossed on the thin film is rotated about a pivot point located at any position along the thin film. This pivot point may be, for example, at either end or at the center of gravity. The energy source, energizable to move the thin film, may be provided in any number of electromagnetic configurations. One such configuration includes the combination of an energizable coil, or multiple coils, with the thin film, the combination being pivoted at the center. Magnets are located either below or to the sides of the film such that when the coils are energized, a magnetic flux is created and the film with its diffractive grating rotates about the pivot axis. Such structures are described in further detail in U.S. Pat. No. 5,613,022, entitled “Diffractive Display and Method Utilizing Reflective or Transmissive Light Yielding Single Pixel Full Color Capability,” issued Mar. 18, 1997, which hereby is expressly incorporated herein by reference.

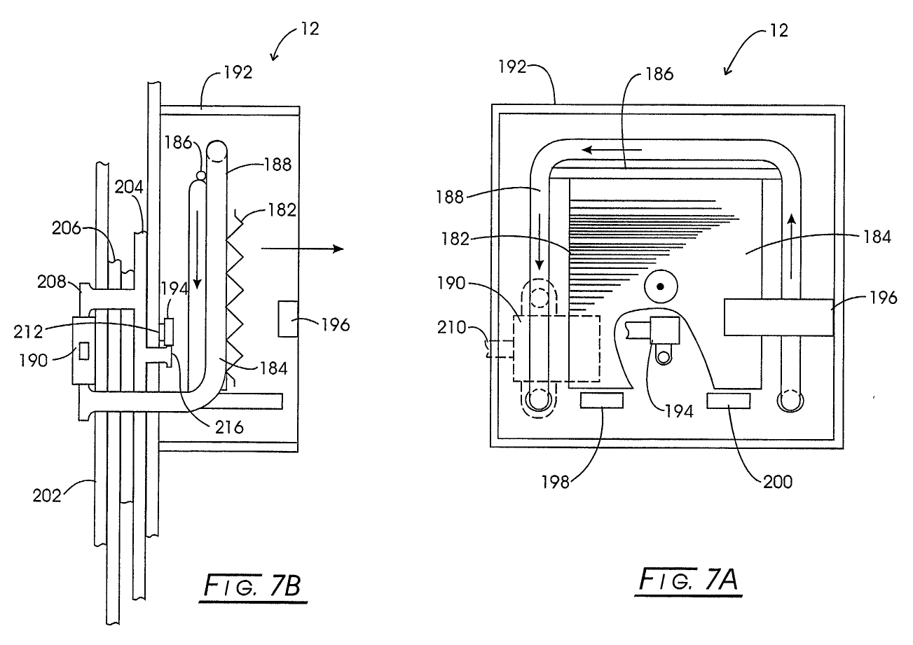

Looking now to FIG. 7A, a top view of one embodiment of an RDOE, shown generally at 12, is revealed to include the improved moving magnet embodiment. A holographic diffraction grating is provided at 182. Diffractive grating 182 is attached to a magnetic component that is a permanent magnet (shown at 184 in FIG. 7B). Diffractive grating 182 may be physically attached to magnet 184 or, alternatively, diffractive grating 182 and magnet 184 each may be affixed to an additional element to form the attachment. Magnet 184 rests upon pivot 186 which is made of ferromagnetic material and, therefore, attracts magnet 184 and holds it in place while still allowing the tilting motion to take place about pivot 186. Connecting to, part of, or adjacent to, pivot 186 is current carrying conductor 188 that is connected to FET (field effect transistor) 190. As such, magnet 184 and coil 188 are magnetically coupled.

With current flowing through wire 188, a magnetic field is created which exerts a force on magnet 184. Because magnet 184 is not in a permanently fixed position, the force created by the current in wire 188 will cause magnet 184, and associated diffractive grating 182, to rotate about pivot 186. The direction of rotation of magnet 184, and associated diffractive grating, about pivot 186 depends on the direction of the magnetic field associated with magnet 184 and the direction of current flowing through wire 188. Reversing the polarity of the current in wire 188 changes the direction of the force created, causing the magnet to rotate in the opposite direction. Electromagnetic shielding 192 is provided to prevent the interaction of fields generated by external sources. This shielding may be composed, for example, of SAE 1010 steel. As will be obvious to one skilled in the art, alternative configurations can be envisioned to electromagnetically couple magnet 184 and coil 188 for movement of the magnet. Several illustrative configurations are described in greater detail later.

Stops 194 and 196 prevent the rotation of magnet 184 beyond desired bounds. A portion of magnet 184 has been cut away to reveal the presence of stop 194. Stop 194 may include a capacitance probe or sensor which senses the presence of a capacitor (not shown), for example, composed of aluminized Mylar®, which is located below magnet 184 and indicates the position of magnet 184. Once the magnet has been driven to a desired position, it is held in place by the magnetic fields surrounding ferromagnetic pins 198 and 200. Because of the presence of these pins, magnet 184 may be held in position with little or no current flowing in wire 188. Turning now to FIG. 7B, a side view of the RDOE of FIG. 7A is shown revealing the connection of the above-described elements to a printed circuit board. Numeration from FIG. I is retained. Printed circuit board (PCB) 202 is seen to have ground plane 204 and + voltage bus 206. FET 190 is connected in series with conductor 188, ground connector 208 and + voltage connector 210 (FIG. 1) being connected to ground plane 204 and + voltage bus 206, respectively. Similarly, the capacitance sensor located on stop 194 is connected to ground plane 204 at 211 and + voltage bus 206 at 212. The connection of elements to PCB 280 is intended to be illustrative and not limiting of the present invention, as it will be obvious to those skilled in the art that other arrangements may be provided.

In addition to RDOEs involving manipulated films or pivoted magnets or coils, the present invention may be implemented using one of a number of planar rotational embodiments of RDOE 12. For each of these embodiments, an array of facets may be achieved on the RDOE by providing a single diffraction grating of constant spacing or an array of diffraction gratings, each of which may have a different spacing wherein each diffraction grating element of the array may be disposed in juxtaposition or may be spaced apart, or by using a holographic diffraction grating array wherein the array of facets are superimposed. With a single diffraction grating, a facet is associated with each rotational position of the FRE, thus creating an array of facets to an observer. Where each facet of the array is a separate diffraction grating, the facets may be non-uniformly or uniformly placed along or across RDOE 12, however, the location of each facet within the array is known, for example, each location can be stored in the memory of a microprocessor. With the location of each facet in the array know, the RDOE may be rotated such that input signal(s) illuminate select facet(s). Thus, desired output signal(s) are generated and directed to appropriate output station(s).

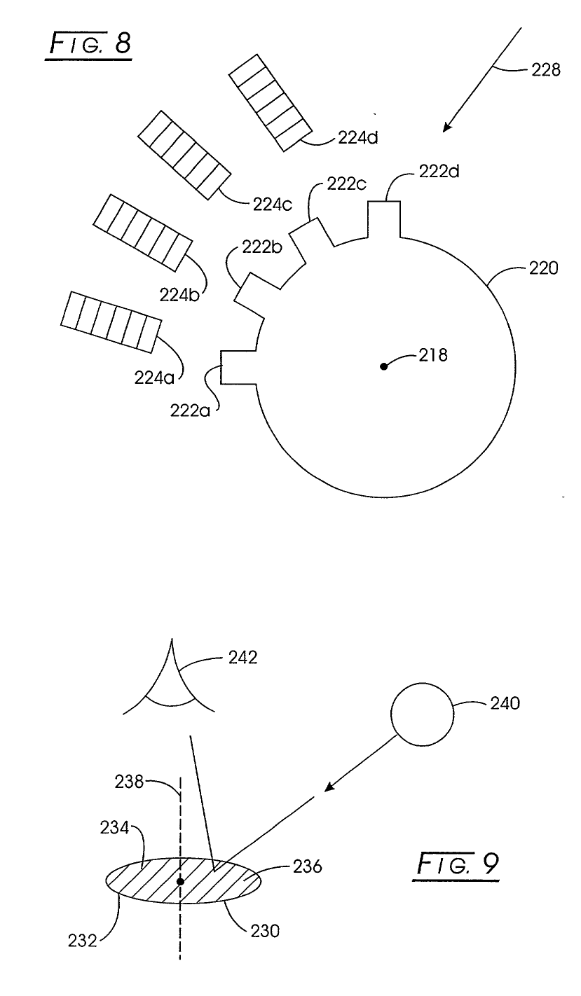

FIG. 8 depicts a first planar rotational embodiment of RDOE 12. Posts 222a-222d extend from the outer periphery of selectively movable plate 220. To facilitate movement, plate 220 may be formed being substantially flat and circular. A facet, in the form of a diffractive grating having a particular or constant grating spacing, such as formed from a photoresist (holographic diffractive grating), is carried on the outer end of each post 222a-222d. Each facet diffracts wavelengths at different angles. When optical source 228 is projected onto plate 220 it strikes post 222d according to the position of plate 220 in FIG. 8 for diffracting energy from source 228 according to the grating spacing carried on the end of post 222d. By suitable rotation of plate 220, post 222c, 222b, or 222a could be positioned to intercept source 228 for diffracting different levels of energy, again according to their diffraction grating spacing. It will be appreciated that rotating plate 220 can take the place of RDOE 12 in FIG. 7, for example.

Movement of plate 220 can come from at least two different sources. Plate 220 could be attached at its center 218 to the spindle of a stepper motor (not shown) that may conveniently be manufactured to have a 0.1° resolution, for rotation of plate 220 about axis 218 to bring each of the posts, 222a-222d, into position to intercept source 228. A linear actuator also may be pivotally attached to plate 220 to cause its rotation about axis 218. Alternatively, plate 220 could bear magnets that interact with energizable coils 224a-224d, again for rotating plate 220 about center 218. Alternately, plate 220 could bear the coils and one or more permanent magnets could replace the coils as depicted in FIG. 8. Alternately, electrostatics could be used to drive the rotation of plate 220. Of course, combinations of these motive methods, as well as other motive methods, could be employed to rotate plate 220, as those skilled in the art will appreciate.

Looking to FIG. 9 another rotational embodiment of RDOE 12 is shown. A plate similar to that shown in FIG. 8 is revealed generally at 230. Plate 230 has an outer periphery 232 and a top surface 234. For this embodiment, an array of facets is provided along top surface 234 rather than along periphery 232 as previously shown. Instead of providing posts each of which bears a diffraction grating with a unique spacing, the array of facets may be provided across the surface of plate 230. In its simplest form, plate 230 may bear a single diffraction grating, 236, which has a constant grating spacing. As plate 230 is rotated, a different signal will be diffracted to eye station 242, each rotational position of RDOE 12 representing a facet. The number of facets in the array, thus, will be determined by the number (or plurality) of positions to which RDOE 12 may be rotated. Alternatively, it may be advantageous to provide a plurality of diffraction gratings (having the same or different spacing) on the surface of plate 230 to create an array facets of RDOE 12, wherein each diffraction grating element of the array may be disposed in juxtaposition or may be spaced apart. Thus, as plate 230 is rotated about its axis, for example as shown at 238, light from optical source 240 will be diffracted at different angles to eye station 242 depending on the position of the plate and the particular facet or grating spacing being illuminated. Variation of the effective spacing of diffraction grating 236 is most readily achieved by use of a holographic diffraction grating as described above. By rotating plate 230 with grating 236, a single input signal may be diffracted into a plurality of output wavelengths, the number of output wavelengths being commensurate with the number of variations in grating spacing along the plate. The shape of plate 230 is shown in FIG. 9 as being circular, however, other shapes may be preferred. Those skilled in the art will appreciate that the shape of the plate may be designed to maximize the number of areas of varying grating spacing and resulting output signals. Rotation of plate 230 may be accomplished utilizing electrostatics, a linear actuator, or a stepper motor as described previously in connection with FIG. 8.

Preferably, an array of facets may be provided across the surface of plate 230 by using a holographic diffraction grating array wherein the array of facets are superimposed, each facet being angularly oriented or offset with respect to each other. Thus, the holographic film is developed such that at a given position of plate 230 with respect to the source, a particular output signal is generated and directed to a select output station. For example, if plate 230 is rotated 2°, i.e. from an initial position of 0°, incident light of wavelength λ₁ is diffracted and the generated output signal directed to a first output station. By rotating plate 230 to another position, for example 9° from the initial position, input signal λ₁ is diffracted and the generated output signal directed to a second output station. For each position of the RDOE, multiple facets may be illuminated simultaneously by multiple input signals to direct multiple output signals to multiple output stations. Rotation of plate 230 may be effected as previously described. Utilizing any of these rotational approaches, the number of output signals that may be generated by RDOE 12 is limited by the number of positions to which the RDOE may be rotated.

While the foregoing description has been addressed to the use of an RDOE, a movable diffractive optical element (MDOE) could be used for movement of a diffraction grating in x-y-z coordinates. It will be appreciated, however, that for efficiency purposes an RDOE represents a preferred embodiment.

In this application all citations are expressly incorporated herein by reference.

We claim:

1. Method for treating optical signals from a source thereof, which comprises the steps of:
(a) directing a source of input optical signal(s) onto a movable diffractive optical element (MDOE) to generate output signals(s), each of said input signal(s) being associated with a given wavelength;
(b) supplying one or more output station(s); and
(c) moving said MDOE to distribute said output optical signal(s) among said output station(s).

2. The method of claim 1, wherein said MDOE is provided as a rotatable diffraction optical element (RDOE).

3. The method of claim 1, wherein said MDOE is provided as a magnet having a holographic diffraction grating attached thereto, and being magnetically coupled to a coil energizable for movement of said magnet and said diffraction grating.

4. The method of claim 2, wherein said RDOE is provided having an array of facets, each of said facets carrying diffraction grating(s).

5. The method of claim 4, wherein a selectively movable plate is provided as said MDOE, said plate bearing said array of facets, each of said facets comprising a post having an outer surface carrying said diffraction grating(s).

6. The method of claim 5, wherein said selectively movable plate is provided as a substantially flat, circular plate having an outer periphery and an axis, said posts being disposed about said periphery, said plate being rotatable about said axis.

7. The method of claim 5, wherein said diffraction gratings are provided as holographic diffraction gratings.

8. The method of claim 4, wherein a selectively rotatable plate having a surface and a periphery is provided as said RDOE, said surface carrying said array of facets which are superimposed holographic diffraction grating(s), each being angularly offset with respect to each other, which diffract said input signal(s) into a plurality of output signals.

9. The method of claim 1, wherein laser diode(s) are provided as said source.

10. The method of claim 1, wherein fiber optic cable(s) are provided as said source.

11. The method of claim 1, wherein fiber optic cable(s) are provided as said output station(s).

12. The method of claim 1, wherein optical detector(s) are provided as said output station(s).

13. The method of claim 1, further including the steps of:
(d) providing a first lens assembly for focusing said source of input signal(s) onto said MDOE; and
(e) providing a second lens assembly for focusing said distributed output optical signal(s) from said MDOE onto said output station(s).

14. The method of claim 2, further including the steps of:
(d) providing a first lens assembly for focusing said source of input signal(s) onto said RDOE; and
(e) providing a second lens assembly for focusing said distributed output optical signal(s) from said RDOE onto said output station(s).

15. The method of claim 1, further including the step of optically combining selected said output station(s) by combiner(s).

16. The method of claim 4, wherein said RDOE comprises a holographic diffraction grating of constant spacing and said RDOE has an axis, said RDOE being rotatable about said axis to a plurality of stations to create said array of facets.

17. A system for treating optical signals from a source thereof, which comprises:
(a) a source carrying input optical signal(s), each of said signal(s) being associated with a particular wavelength;
(b) a movable diffractive optical element (MDOE) positioned to intercept said input optical signal(s) for generating and distributing output optical signal(s) and;
(c) output station(s) positioned to receive said output optical signal(s) from said MDOE.

18. The system of claim 17, wherein said MDOE comprises a rotatable diffraction optical element (RDOE).

19. The system of claim 18, wherein said RDOE comprises a magnet having a holographic diffractive grating attached thereto and being magnetically coupled to a coil energizable for movement of said magnet and said diffraction grating.

20. The system of claim 18, wherein said RDOE includes an array of facets, each element of said array carrying diffraction grating(s).

21. The system of claim 19, wherein said RDOE comprises a selectively movable plate bearing an array of facets, each of said facets comprising a post having an outer surface carrying a diffraction grating.

22. The system of claim 21, wherein said selectively movable plate is a substantially flat, circular plate having an outer periphery and an axis, said posts being disposed about said periphery, said plate being rotatable about said axis.

23. The system of claim 21, wherein said diffraction grating is a holographic diffraction grating.

24. The system of claim 17, wherein said source comprises laser diode(s).

25. The system of claim 17, wherein said source comprises fiber optic cable(s).

26. The system of claim 17, wherein said output station(s) comprise optical fiber(s).

27. The system of claim 17, wherein said output station(s) comprise optical detector(s).

28. The system of claim 17, further including:
(d) a first lens assembly for focusing said source of input signal(s)onto said MDOE; and
(e) a second lens assembly for focusing said distributed output optical signal(s) from said MDOE onto said output station(s).

29. The system of claim 18, further including:
(d) a first lens assembly for focusing said source of input signal(s) onto said RDOE; and
(e) a second lens assembly for focusing said distributed output optical signal(s) from said RDOE onto said output station(s).

30. The system of claim 17, wherein selected said output station(s) are optically connected to combiner(s).

31. The system of claim 17, wherein said MDOE bears a holographic diffraction grating.

32. In a method for treating optical signals wherein optical signals provided by fiber optic cable(s) or laser diode(s) as input optical signals are distributed among output stations as output optical signals, each of said output stations comprising optical connector(s) positioned to receive said output optical signals, said optical connectors being selectively combinable to permit any combination of said output optical signals, the improvement which comprises the steps of:
(a) directing said source of input optical signals onto a movable diffractive optical element (MDOE) to generate output signals, each of said input signals being associated with a given wavelength; and
(b) moving said MDOE to distribute said output optical signals among said output stations.

33. The method of claim 32, wherein said input optical signals are multiplexed.

34. The method of claim 32, wherein said input optical signals are demultiplexed.

35. The method of claim 32, wherein said input optical signals are switched.

36. The method of claim 32, wherein said MDOE is provided as a rotatable diffractive optical element (RDOE).

37. The method of claim 36, wherein a selectively movable plate which is substantially flat and circular is provided as said RDOE, said plate having an outer periphery and an axis, said posts being disposed about said periphery, said plate being rotatable about said axis.

38. The method of claim 37, further including the steps of:
(c) providing a first lens assembly for focusing said source of input signals onto said RDOE; and
(e) providing a second lens assembly for focusing said distributed output optical signals from said RDOE onto said output stations.

39. The method of claim 36, wherein said RDOE comprises a holographic diffraction grating of constant spacing and said RDOE has an axis, said RDOE being rotatable about said axis to distribute said output optical signals among said output stations.
